(19) United States
(12) Patent Application Publication
(10) Pub. No.: US 2010/0106869 A1
(43) Pub. Date: Apr. 29, 2010

(54) USB Storage Device and Interface Circuit Thereof

(75) Inventor: Shengzhong Su, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: Semiconductor Manufacturing International (Shanghai) Corporation, Shanghai (CN)

(21) Appl. No.: 12/336,451

(22) Filed: Dec. 16, 2008

(30) Foreign Application Priority Data
Oct. 24, 2008 (CN) 200810201783.4

(51) Int. Cl. G06F 3/00

(52) U.S. Cl. 710/33

(57) ABSTRACT

A USB storage device and an interface circuit thereof are disclosed. The interface circuit of the USB storage device includes an out transaction execution unit, which controls a speed status of the out transaction according to a speed status mark recorded in the speed status register, and therefore it is not necessary to provide a control unit for each of the high-speed out transaction and the full-speed out transaction, so that the area of the interface circuit is reduced, thereby reducing the area of the USB storage device.

### FIELD OF THE INVENTION

The present invention relates to a memory device, and particularly to a USB storage device and an interface circuit thereof.

### BACKGROUND OF THE INVENTION

Universal Serial BUS (USB) is a bus standard aiming to provide a connection between a host (for example a Personal Computer) and various peripheral equipments with a low cost. Presently, such a peripheral connection standard of the Personal Computer has evolved to version USB 2.0, the data transmission rate of which is up to 480 Mbps. The existing USB storage device conforming to such a fast connection standard typically includes a controller circuit and a memory. The controller circuit may include an interface circuit between the memory and the host. For example, as shown in FIG. 1, the interface circuit generally includes six status control units including: a transmission speed status control unit 1 used for controlling the USB storage device to be at a corresponding transmission speed status according to the detected current speed status of the host; a transfer mode control unit 2 used for controlling the USB storage device to be at a corresponding transfer mode according to the obtained information of transfer mode, and the transfer mode of the USB storage device includes a control transfer mode, a bulk transfers mode, a synchronous transfer mode and so on; a high-speed control detection unit 3 used for notifying the host memory whether free space is available in the USB storage device according to a memory detection signal of the USB storage device when the USB storage device is at a high-speed transmission speed status; an in transaction execution unit 4 used for controlling the transmission status of data inputting according to the memory detection signal, the information of transfer mode and information of transmission speed; a full-speed out transaction control unit 5 used for causing the USB storage device to be at a full-speed out transaction status according to a full-speed transmission signal, the detection signal and the information of transfer mode; and a high-speed out transaction control unit 6 used for causing the USB storage device to be at a high-speed out transaction status according to a high-speed transmission signal, the detection signal and the information of transfer mode.

Some more information related to the status control is introduced in, for example, U.S. Pat. No. 7,167,928.

With the trend of miniaturization of the USB storage device, it is necessary not only to further reduce the memory area with improved semiconductor technologies, but also to reduce the controller circuit area.

### SUMMARY OF THE INVENTION

An object of the present invention is to reduce the controller circuit area in response to the trend of miniaturization of the USB storage device.

An embodiment of the present invention provides an interface circuit of the USB storage device, including:

a transmission speed detection unit, adapted to detect a current speed status of a host;

a speed status register, adapted to record the current speed status of the host that is detected by the transmission speed detection unit, and mark the speed status as a high-speed transmission status or a full-speed transmission status accordingly;

a transfer mode obtaining unit, adapted to obtain information of transfer mode;

an in transaction execution unit, adapted to execute data in transaction at a corresponding transfer mode and a corresponding speed status according to the information of transfer mode obtained by the transfer mode obtaining unit and a speed status mark recorded in the speed status register, when a detection signal of a memory of the USB storage device indicates existence of effective data to be returned to the host; and

an out transaction execution unit, adapted to execute data out transaction at a corresponding transfer mode and a corresponding speed status according to the information of transfer mode obtained by the transfer mode obtaining unit and the speed status mark recorded in the speed status register, when the detection signal of the memory of the USB storage device indicates availability of free space in the memory of the USB storage device.

An embodiment of the present invention provides a USB storage device including a memory and an interface circuit, and the interface circuit includes:

a transmission speed detection unit, adapted to detect a current speed status of the host;

a speed status register, adapted to record the current speed status of the host that is detected by the transmission speed detection unit, and mark the speed status as a high-speed transmission status or a full-speed transmission status accordingly;

a transfer mode obtaining unit, adapted to obtain information of transfer mode;

an in transaction execution unit, adapted to execute data in transaction at a corresponding transfer mode and a corresponding speed status according to the information of transfer mode obtained by the transfer mode obtaining unit and a speed status mark recorded in the speed status register, when a detection signal of the memory of the USB storage device indicates existence of effective data to be returned to the host; and

an out transaction execution unit, adapted to execute data out transaction at a corresponding transfer mode and a corresponding speed status according to the information of transfer mode obtained by the transfer mode obtaining unit and the speed status mark recorded in the speed status register, when the detection signal of the memory of the USB storage device indicates availability of free space in the memory of the USB storage device.

The inventive USB storage device and the interface circuit thereof are advantageous compared with those in the prior art in that the speed status of the data out transaction is controlled by the out transaction execution unit according to the speed status mark recorded in the speed status register, and therefore it is not necessary to provide a control unit for each of the high-speed out transaction and the full-speed out transaction, so that the area of the interface circuit is reduced, thereby reducing the area of the USB storage device.

### BRIEF DESCRIPTIONS OF THE DRAWINGS

FIG. 1 is a schematic diagram showing the structure of the interface circuit of the USB storage device in the prior art;

FIG. 2 is a schematic diagram showing the interface circuit of the USB storage device according to an embodiment of the present invention;

FIG. 3 is a schematic diagram showing the USB storage device including the interface circuit shown in FIG. 2;

FIG. 4 is a schematic diagram showing a storage mode of the memory of the USB storage device in the prior art; and

FIG. 5 is a schematic diagram showing a storage mode of the memory of the USB storage device shown in FIG. 3.

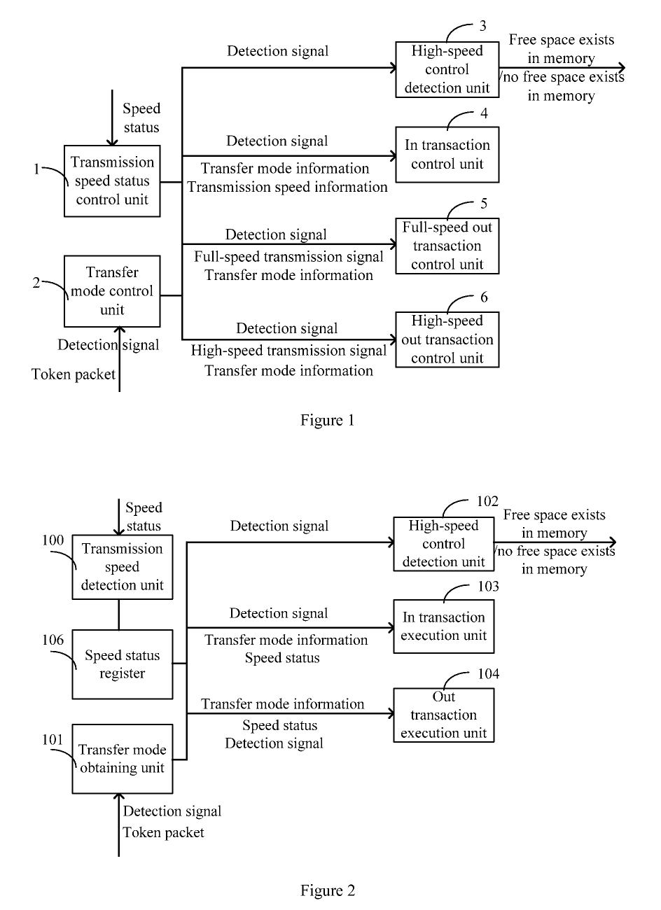

### DETAILED DESCRIPTIONS OF THE EMBODIMENTS

With reference to FIG. 2, the interface circuit of the USB storage device according to an embodiment of the present invention includes:

a transmission speed detection unit 100, adapted to detect the current speed status of the host;

a speed status register 106, adapted to record the current speed status of the host that is detected by the transmission speed detection unit, and mark the speed status as a high-speed transmission status or a full-speed transmission status accordingly;

a transfer mode obtaining unit 101, adapted to obtain information of transfer mode;

an in transaction execution unit 103, adapted to execute data in transaction at a corresponding transfer mode and a corresponding speed status according to the information of transfer mode obtained by the transfer mode obtaining unit and a speed status mark recorded in the speed status register when a detection signal of the memory of the USB storage device indicates existence of effective data to be returned to the host; and

an out transaction execution unit 104, adapted to execute data out transaction at a corresponding transfer mode and a corresponding speed status according to the information of transfer mode obtained by the transfer mode obtaining unit and the speed status mark recorded in the speed status register when the detection signal of the memory of the USB storage device indicates availability of free space in the memory of the USB storage device.

In the present embodiment, the transmission speed detection unit 100 writes the detected current speed status of the host into the speed status register, and marks the current speed status of the host as the high-speed transmission status or the full-speed transmission status according to the differentiation between the high-speed transmission status and the full-speed transmission status. The in transaction execution unit 103 and the out transaction execution unit 104 controls the speed status of the data input and the data output according to the speed status mark recorded in the speed status register, respectively.

With reference to FIG. 2 again, the interface circuit according to an embodiment of the present invention further includes: a high-speed control detection unit 102 which notifies the host whether free space is available in the memory of the USB storage device when the USB storage device is at the high-speed transmission speed status.

It is noted that the in transaction and out transaction are described by using the host (for example a Personal Computer) connected to the USB storage device as a reference in the present embodiment and the following embodiments. In other words, using the host as the reference, the out transaction means data transmission from the host to the USB storage device, and the in transaction means data transmission from the USB storage device to the host.

The operation of a USB storage device including the above interface circuit is described illustratively in detail below.

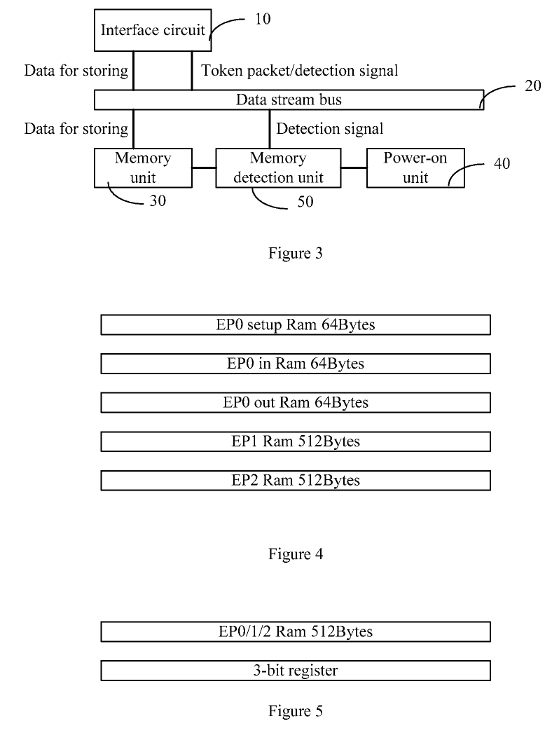

With reference to FIG. 3, the USB storage device includes an interface circuit 10, a data stream bus 20, a memory unit 30, a power-on unit 40 and a memory detection unit 50. The data stream bus 20 includes a data pipe for transferring the data in the memory unit 30 and a message pipe for transferring various control signals.

The procedures of the in transaction and the out transaction of the USB storage device are described below by way of example.

The procedure of the in transaction (data transmission from the USB storage device to the host) is as follows.

With reference to both FIGS. 2 and 3, to operate the USB storage device, the power-on unit 40 first powers on the USB storage device, thereafter, the transmission speed detection unit 100 and the memory detection unit 50 start to operate, while the other components are idle (generally controlled by the host).

After the power on, the transmission speed detection unit 100 detects the current speed status of the host, so that the speed status of the USB storage device is consistent with that of the host in the subsequent data transmission, to avoid an error in the data transmission. Generally, the default speed status is the full-speed transmission status. After detecting the current speed status of the host, the transmission speed detection unit 100 writes the current speed status of the host into the speed status register 106 for recording the current speed status.

After the power on, the memory detection unit 50 detects in real time whether effective data required to be returned to the host exists in the memory unit 30. If the effective data required to be returned to the host exists in the memory unit 30, the memory detection unit 50 sends to the interface circuit 10 a detection signal indicating the existence of the effective data required to be returned to the host in the memory via the message pipe of the data stream bus 20; and if no effective data required to be returned to the host exists in the memory unit 30, the memory detection unit 50 sends to the interface circuit 10 a detection signal indicating non-existence of the effective data required to be returned to the host in the memory via the message pipe of the data stream bus 20.

With reference to both FIGS. 2 and 3 again, after obtaining the detection signal indicating the existence of the effective data required to be returned to the host in the memory unit 30 via the message pipe of the data stream bus 20, the transfer mode obtaining unit 101 forwards the detection signal to a currently operative unit of the interface circuit 10. For example, the transfer mode obtaining unit 101 in the present embodiment forwards the detection signal to the in transaction execution unit 103. During the operation of the in transaction execution unit 103, the in transaction execution unit 103 accesses first the speed status register 106 recording the current speed status to obtain the current speed status of the host, thereby determining the data storage speed. For example, if the value in the register indicates the full-speed status, the data storage speed is full-speed, and if the value in the register indicates the high-speed status, the data storage speed is high-speed.

Next, when the host sends an in token packet to the USB storage device to request the data transferring from the USB storage device, if perceiving that the effective data required to be returned to the host exists in the memory unit 30 through the detection signal forwarded by the transfer mode obtaining unit 101, the in transaction execution unit 103 generates a control signal used to control the effective data to be returned to the host correctly. The token packet may include information of data transfer mode to provide the information of the transfer mode in which the in transaction execution unit 103 transmits the data. For the USB storage device having a plurality of devices, the token packet may further include a device address to provide the information of the device from which the in transaction execution unit 103 reads the data to be transmitted to the host.

When the host sends an in token packet to the USB storage device to request the data transferring from the USB storage device, if the in transaction execution unit 103 perceives that no effective data required to be returned to the host exists in the memory unit 30 through the detection signal forwarded by the transfer mode obtaining unit 101, the in transaction execution unit 103 generates and returns a handshake signal to the host to notify the host that no effective data required to be returned to the host exists in the USB storage device, and the host sends repeatedly the in token packet to the USB storage device to request the data transferring from the USB storage device, until the in transaction execution unit 103 perceives that the effective data required to be returned to the host exists in the memory unit 30 through the detection signal, and generates a control signal used to control the effective data to be returned to the host correctly.

As described above, the token packet includes the information of the transfer mode, so that the in transaction execution unit 103 needs to determine the transfer mode for data transmission. The transfer mode obtaining unit 101 reads the information of transfer mode from the token packet to obtain the transfer mode, and writes the transfer mode into the register recording the current transfer mode status. The in transaction execution unit 103 determines the transfer mode for data transmission by accessing the register.

For example, the information of transfer mode in the token packet indicates the mode of bulk transfers.

For the sake of description, the mode of bulk transfers is described briefly. The mode of bulk transfers means a transfer type designed to support communication of relatively large amount of data at highly variable time, where the transfer can use any available bandwidth. The mode of bulk transfers is characterized by:

Access to the USB bus on a bandwidth-available basis;

Retry of transfers, in the case of occasional delivery failure due to errors on the bus;

Guaranteed delivery of data but no guarantee of bandwidth or latency.

The bulk transfers occur only on a bandwidth-available basis. For a USB with large amount of free bandwidth, bulk transfers may happen relatively quickly. For a USB with little bandwidth available, bulk transfers may trickle out over a relatively long period of time. Therefore, the bulk transfers are non-periodic, large-packet bursty communication, typically used for data that can use any available bandwidth and can also be delayed until the bandwidth is available.

After determining that the transfer mode is the bulk transfers mode according to the token packet, the transfer mode obtaining unit 101 writes the information of the bulk transfers mode into the register for recording the current transfer mode status. For example, when the available bandwidth exists, the in transaction execution unit 103 reads the corresponding data from the memory unit 30 and transmits the data to the host.

Similarly, if the information of transfer mode in the token packet indicates a control transfer mode, a procedure similar to that described above is carried out and description thereof is omitted.

For the sake of better understanding, the control transfer mode is described briefly. The control transfers allow accessing to different parts of a device. The control transfers are intended to support communication flow of configuration, command and status type between client software and its function. The control transfers include transactions including: (1) a Setup bus transaction of moving request information from host to its function; (2) zero or more data transactions of sending data in the direction indicated by the Setup transaction; and (3) A Status transaction of returning status information from the function to the host. That is, the returned status information is “success” when the endpoint completes successfully the required operation.

Therefore, the control transfer refers to the reliable and non-periodic transferring of a request or response initiated by the host software, and is typically used for the command and status operations.

Likewise, the above-described method is also applicable to the other USB transfer modes.

The procedure of out transaction (data transmission from the host to the USB storage device) is as follows.

In the procedure of out transaction, the procedures of power on and the transmission speed detection unit 100 are similar to those in the procedure of in transaction, and description thereof is omitted.

After power on, the memory detection unit 50 detects in real time whether free space is available in the memory unit 30. If the free space is available in the memory unit 30, the memory detection unit 50 sends to the interface circuit 10 a detection signal indicating the availability of the free space in the memory via the message pipe of the data stream bus 20; and if no free space is available in the memory unit 30, the memory detection unit 50 sends to the interface circuit 10 a detection signal indicating unavailability of free space in the memory via the message pipe of the data stream bus 20.

With reference to both FIGS. 2 and 3 again, after obtaining the detection signal indicating the availability of the free space in the memory unit 30 via the message pipe of the data stream bus 20, the transfer mode obtaining unit 101 forwards the detection signal to the currently operative unit of the interface circuit 10. For example, the transfer mode obtaining unit 101 forwards the detection signal to the out transaction execution unit 104 in the present embodiment. During the operation of the out transaction execution unit 104, the out transaction execution unit 104 accesses first the speed status register recording the current speed status to obtain the speed status for storing the data. For example, if the value in the register indicates the full-speed status, the data storage speed is full-speed, and if the value in the register indicates the high-speed status, the data storage speed is high-speed. Because the data output is under the control of the out transaction execution unit 104, without providing respectively a full-speed out transaction execution and a high-speed out transaction execution unit for controlling, the area of the interface circuit is reduced.

Next, when the host sends an out token packet to the USB storage device to request for data transferring to the USB storage device, if perceiving that free space is available in the memory unit 30 through the detection signal forwarded by the transfer mode obtaining unit 101, the out transaction execution unit 104 generates a control signal used to control the USB storage device to receive the data correctly, and further generates a handshake signal to be returned to the host to notify the host that the data sent from the host has been received correctly. The token packet may include information of data transfer mode to provide the information of the transfer mode in which the out transaction execution unit 104 transmits the data. For the USB storage device having a plurality of devices, the token packet may further include a device address to provide the information of the device to which the out transaction execution unit 104 transmits the data.

When the host sends an out token packet to the USB storage device to request for data transferring to the USB storage device, if perceiving that no free space is available in the memory unit 30 through the detection signal forwarded by the transfer mode obtaining unit 101, the out transaction execution unit 104 generates a handshake signal to be returned to the host to notify the host of the unavailability of free space in the USB storage device.

At this time, if the transmission speed is at the full-speed status, the host sends repeatedly the out token and data packet to the USB storage device to request the data transferring to the USB storage device, until the out transaction execution unit 104 perceives that free space is available in the memory unit 30 through the detection signal forwarded by the transfer mode obtaining unit 101, then the out transaction execution unit 104 generates a control signal used to control the USB storage device to receive the data correctly, and further generates a handshake signal to be returned to the host to notify the host of the correct receipt of the data sent from the host.

At this time, if the transmission speed is at the high-speed status, the host sends periodically a token packet to the USB storage device, to control the high-speed control detection unit 102 to detect the detection signal of the memory. When perceiving the availability of free space in the memory unit 30 according to the detection signal of the memory, the high-speed control detection unit 102 returns to the host a handshake signal to notify the host of the availability of the free space in the memory unit 30. Then the host sends an out token packet to the USB storage device to request the data transferring to the USB storage device, subsequently the out transaction execution unit 104 generates a control signal used to control the USB storage device to receive data correctly, and further generates a handshake signal to be returned to the host to notify the host of the correct receipt of the data sent from the host.

As described above, the token packet includes the information of the transfer mode. When transferring the data, the out transaction execution unit 104 needs to determine the transfer mode for data transferring. Reference may be made to the embodiment of the data input procedure, and the out transaction execution unit 104 also determines the transfer mode according to the value in the register for recording the current transfer mode.

To further reduce the area of the USB storage device, it is possible to further modify the storage mode of the memory.

FIG. 4 is a schematic diagram showing the storage mode of the memory in the prior art. For example, three RAMs each having a size of 64 Bytes are respectively used to control three transfer modes of setup, in and out, and defined as EP0 setup, EP0 in and EP0 out. One RAM having a size of 512 Bytes is used for bulk in transfers and defined as EP1. Another RAM having a size of 512 Bytes is used for the bulk out transfers and defined as EP2. Consequently, all the RAMs to perform the various transfer modes of the USB storage device have a size of 64+64+512+512=1152 Bytes. Thus, the required RAMs have a large size, as a result, the area of the USB storage device is relatively large. Further, the RAMs other than the one used for the currently operative transfer mode are idle.

However, the storage mode of the memory as shown in FIG. 5 addresses the above problem. With reference to FIG. 5, for example, only one RAM having a size of 512 Bytes are used for all the transfer modes, and a register of 3 bits is used for selecting the transfer mode. For example, it is defined that the EP0 setup corresponds to a register value of 000, the EP0 out corresponds to a register value of 001, the EP0 in corresponds to a register value of 010, the EP 1 corresponds to a register value of 011, and the EP2 corresponds to a register value of 100. In the case of a certain transfer mode, a RAM having a size suitable for the transfer mode may be provided according to the value in the register. The RAM required for the storage mode has only a size of 512 Bytes+3 bits, which is much reduced compared with the above storage mode as shown in FIG. 4, so that the area of the USB storage device is further reduced.

The foregoing description is merely illustrative of the preferred embodiments of the invention, and is not intended to limit the scope of the invention. Various modifications and variations may be made by the skilled in the art without departing from the principles and scope of the invention. The scope of the invention is interned to be defined by the appended claims.

1. An interface circuit of a USB storage device, comprising:
a transmission speed detection unit, adapted to detect a current speed status of a host;
a speed status register, adapted to record the current speed status of the host that is detected by the transmission speed detection unit, and mark the speed status as a high-speed transmission status or a full-speed transmission status accordingly;
a transfer mode obtaining unit, adapted to obtain information of transfer mode;
an in transaction execution unit, adapted to execute in transaction at a corresponding transfer mode and a corresponding speed status according to the information of transfer mode obtained by the transfer mode obtaining unit and a speed status mark recorded in the speed status register, when a detection signal of a memory of the USB storage device indicates existence of effective data to be returned to the host; and
an out transaction execution unit, adapted to execute out transaction at a corresponding transfer mode and a corresponding speed status according to the information of transfer mode obtained by the transfer mode obtaining unit and the speed status mark recorded in the speed status register, when the detection signal of the memory of the USB storage device indicates availability of free space in the memory of the USB storage device.

2. The interface circuit of the USB storage device of claim 1, wherein the information of transfer mode is obtained by the transfer mode obtaining unit from a token packet sent by the host to the USB storage device.

3. The interface circuit of the USB storage device of claim 1, further comprising a register for recording the information of transfer mode obtained by the transfer mode obtaining unit, wherein the in transaction execution unit and the out transaction execution unit obtains the information of transfer mode from the register for recording the information of transfer mode.

4. The interface circuit of the USB storage device of claim 1, wherein the transfer mode comprises a bulk transfers mode and a control transfer mode.

5. A USB storage device comprising a memory and an interface circuit, wherein the interface circuit comprises:
a transmission speed detection unit, adapted to detect a current speed status of a host;
a speed status register, adapted to record the current speed status of the host that is detected by the transmission speed detection unit, and mark the speed status as a high-speed transmission status or a full-speed transmission status accordingly;
a transfer mode obtaining unit, adapted to obtain information of transfer mode;
an in transaction execution unit, adapted to execute in transaction at a corresponding transfer mode and a corresponding speed status according to the information of transfer mode obtained by the transfer mode obtaining unit and a speed status mark recorded in the speed status register, when a detection signal of a memory of the USB storage device indicates existence of effective data to be returned to the host; and
an out transaction execution unit, adapted to execute out transaction at a corresponding transfer mode and a corresponding speed status according to the information of transfer mode obtained by the transfer mode obtaining unit and the speed status mark recorded in the speed status register, when the detection signal of the memory of the USB storage device indicates availability of free space in the memory of the USB storage device.

6. The USB storage device of claim 5, further comprising a memory detection unit adapted to detect the memory and provide the detection signal.

7. The USB storage device of claim 5, wherein the information of transfer mode is obtained by the transfer mode obtaining unit from a token packet sent by the host to the USB storage device.

8. The USB storage device of claim 5, further comprising a register for recording the information of transfer mode obtained by the transfer mode obtaining unit, wherein the in transaction execution unit and the out transaction execution unit obtains the information of transfer mode from the register for recording the information of transfer mode.

9. The USB storage device of claim 6, wherein the transfer mode comprises a bulk transfers mode and a control transfer mode.

10. The USB storage device of claim 5, wherein the memory comprises a status register and the memory provides memory space required for the bulk transfers and the control transfers according to the value in the status register.
